(19) United States
(12) Patent Application Publication
(10) Pub. No.: US 2015/0234793 A1
(43) Pub. Date: Aug. 20, 2015

(54) FONT RESOURCE MANAGEMENT

(71) Applicant: Adobe Systems Incorporated, San Jose, CA (US)

(72) Inventor: Sairus Patel, Palo Alto, CA (US)

(73) Assignee: Adobe Systems Incorporated, San Jose, CA (US)

(21) Appl. No.: 14/182,683

(22) Filed: Feb. 18, 2014

(51) Int. Cl. G06F 17/21; G06F 9/445; G06F 17/30; G06F 3/0482; G06F 3/0484

(52) U.S. Cl. CPC G06F 17/214; G06F 3/0482; G06F 3/04842; G06F 17/30424; G06F 8/62; G06F 17/30371

(57) ABSTRACT

Techniques are disclosed that allow a user to control how an operating system maintains, updates, installs, and uses font resources provided in a font resource repository. A font resource management module can be configured to detect conflicts between font resources and prompt the user to resolve such conflicts. Conflicts may occur, for example, where Version 1.0 of a given font has been installed and is being used by an operating system, but where Version 2.0 of that same font is later received. Providing the user with the option to select which version of the font should be used by the operating system and other software affords a greater degree of certainty with respect to how content will be rendered for the user. In certain embodiments the font resource management module can be further configured to provide the user with additional information on the font resources that are available.

### FIELD OF THE INVENTION

This disclosure relates generally to management of font resources that are provided by a computer system, and more specifically to workflows that allow a user to control how a computer system maintains, updates, installs, and uses font resources.

### BACKGROUND

In modern usage, the term “font” often refers to a particular typeface having common design features such as weight, style, condensation, width, italicization, ornamentation, and foundry. Fonts have become an important feature of modern computing systems. In particular, users have grown accustomed to having access to, and being able to manipulate, a wide variety of different fonts which can be rendered using output devices such as display screens, projection devices, and printers. As a result, a modern computing system will often include a sizeable collection of raw data that defines the appearance of fonts and enables fonts to be rendered by software running on the computer system. For example, an operating system, a word processor, a web browser, a hardware device driver, and an image editor may all be configured to access font resources that are stored in a font resource repository managed by the operating system itself. This allows a user to access a uniform set of font resources from a variety of different application environments.

### BRIEF DESCRIPTION OF THE DRAWINGS

FIG. 1 is a block diagram schematically illustrating selected components of a computer system that can be used to manage font resources in accordance with certain embodiments of the present invention.

FIG. 2 is a flowchart illustrating an example method for managing font resources in accordance with certain embodiments of the present invention.

FIG. 3A illustrates an example user interface that can be used to provide information about, and receive a user selection regarding, font resources that are managed in accordance with certain embodiments of the present invention.

FIG. 3B illustrates an example user interface that can be used to receive a user selection regarding default handling of font resource conflicts in accordance with certain embodiments of the present invention.

### DETAILED DESCRIPTION

While the font resource repositories included in modern computing systems provide users with access to a wide array of font resources, these repositories and the operating system architectures which are used to manage them suffer from a number of shortcomings. For example, existing operating systems generally do not support having more than one version of the same font installed simultaneously. And even where an operating system allows a user to install multiple versions of a particular font simultaneously, it cannot be guaranteed which of the installed versions will be made available to a given application. This lack of version control is especially problematic for content authors who want their content to have a uniform appearance regardless of future font updates. For example, if a user authors content using Version 1.0 of a given font, she should be able to control whether a subsequent Version 2.0 of the given font is installed by the operating system, since such installation may alter the appearance of previously authored content. Existing font resource management solutions do not provide such functionality with respect to multiple versions of the same font.

Thus, and in accordance with certain embodiments of the present invention, techniques are disclosed herein that allow a user to control how an operating system maintains, updates, installs, and uses font resources provided in a font resource repository. In such embodiments a font resource management module can be configured to detect conflicts between font resources and prompt the user to decide how such conflicts should be resolved. Conflicts may occur, for example, where Version 1.0 of a given font has been installed and is being used by an operating system, but where Version 2.0 of that same font is later received by, or otherwise becomes available to, the operating system. Providing the user with the option to select which version of the font should be used by the operating system and other software affords a greater degree of certainty with respect to how content will be rendered for the user. In certain embodiments the font resource management module can be further configured to provide the user with additional information on the font resources that are available, such as version numbers and release dates, thus allowing the user to make a more informed decision with respect to how font resource conflicts should be resolved. This is particularly helpful where the differences between two versions of the same font are subtle or otherwise difficult to observe. Numerous configurations and variations of such embodiments will be apparent in light of this disclosure.

For instance, one embodiment of the present invention comprises a font management workflow that allows a user to select which version of a font is to be installed, notwithstanding operating system limitations. In particular, when a new font resource is received by or otherwise made available to a font resource management module, it can be determined whether a font resource with the same name has already been installed for use by the operating system. Other conflict detection techniques that are independent of naming conventions can be used in other embodiments. Where conflicting font resources are detected, such as in the case where Version 1.0 of a given font is installed but Version 2.0 of the same font is later received, the user can be provided with information regarding the differences between the two versions. The user can also be prompted to select which of the conflicting font resources should be used by the operating system and other software. For instance, in this example the user can be prompted whether he wishes to (a) continue using the existing Version 1.0, or (b) retry installing the newly received Version 2.0. Where the user wishes to use Version 2.0 of the font, this prompt provides the user with an opportunity to uninstall, delete, or otherwise deactivate Version 1.0 before attempting to install Version 2.0 again. If the user elects to install the newly received Version 2.0 but a font resource conflict still exists, for example due to the presence of an older Version 0.5 or due to an incomplete or failed uninstallation of Version 1.0, the user can again be prompted to resolve the conflict. Certain embodiments include a preferences setting interface that allows the user to define a default rule for resolving font resource conflicts, thereby eliminating the need to prompt the user every time such a conflict is detected. Such a setting could be used, for example, to consistently uninstall older font versions whenever font resource conflicts are detected.

Such embodiments are capable of robustly handling the revisions to font resources that are produced by font foundries from time to time. Such revisions may result in a variety of changes to a font ranging from significant modifications that clearly affect the appearance of the font to metadata modifications that are difficult or impossible to perceive by simply viewing rendered text. A content author who is aware of these revisions will often want to use a particular version of a font, regardless of the fact that a newer version of the font may be available. Thus one advantage of certain of the embodiments disclosed herein is that a font resource management module can be configured to provide a user with a better understanding of how a particular font has been revised, thereby enabling the user to make an informed decision with respect to whether or not the revised font should be installed and used.

One example of a font resource modification that can have a significant impact on the appearance of a font is the addition of new glyphs to a font. This may occur, for instance, when new currency symbols or characters are added to a character set as a result of updates to the relevant standards bodies. Such revisions occurred when Unicode supplemented its character encoding repository with the new currency sign for the European Monetary Union ( [symbol] ) in 1999 and with the new currency sign for the Indian Rupee [symbol] in 2010. Since revisions such as these could significantly affect how content related to these new symbols is rendered, users are likely to want to review such revisions before installing a revised font. Thus in certain embodiments a visual graphic of a new symbol or character, rendered in the font itself, can be displayed to a user in conjunction with the prompt to install the revised font. This may help to alleviate a user's concerns over installing the font revision and provide the user with a better understanding of the potential benefits of using the revised font. Other content may be provided in this context as well, such as instructions for accessing the new glyphs that are provided in a font resource revision using various software applications.

Another type of font resource modification that can significantly affect the appearance of rendered content occurs when a glyph shape or glyph metric changes. Such revisions may occur as a result of font resources having been released with erroneous shapes and/or metrics. This type of revision may be characterized as a bug fix. Changing metrics such as the advance width of a glyph or kerning values associated with a glyph may have significant impacts on the appearance of rendered content since such modifications may affect character spacing, which may in turn affect the location of line and pagination breaks in a document. Thus in certain embodiments a user can be presented with information relating to which glyphs are modified by a particular font resource revision, and how the modifications might affect the appearance of rendered content. This again may help to alleviate a user's concerns over installing the font revision and provide the user with a better understanding of the potential benefits of using the revised font.

Some font resource revisions may have an imperceptible or negligible effect on how content is rendered. Indeed, some such revisions may not affect content rendering at all. For example, font vendors may occasionally modify the user-facing menu names used to refer to a font within a given software environment. Name changes may result from an initial misinterpretation of font standard specifications, or from a desire to better align the font with other software workflows that have a more intuitive interpretation of font name strings. Another example of a font resource revision that may have little or no effect on how content is rendered is the inclusion of new or modified font metadata within the font resource. Font metadata may include, for instance, data defining a range of point sizes for which a particular font is most suitable. Such a range is referred to as “optical size”, and may be expressed as two numbers which define the point size range, such as between 8 points and 11 points. Such information may not have been included in an initial release of a font resource, but may later be added in conjunction with a font resource revision. In such case, a user who installs an updated font resource enables his applications to take advantage of the new values in way that may be beneficial to the user. Since such a revision may not be perceptible by simply inspecting the glyphs themselves, this is another instance where a user can be presented with information relating to how font metadata has been modified and the significance of such modifications.

As used herein the term “font resource” refers, in addition to its ordinary meaning, to information that defines a particular font with sufficient specificity such that the font may be rendered using appropriate software. Such software may include, for example, an operating system, an application such as a word processor or a desktop publisher, or a device driver that is capable of controlling hardware. A font resource may define a set of glyphs, characters or symbols using a matrix of dots (in the case of bitmap fonts) or a collection of lines and/or curves (in the case of outline and stroke fonts). The digital information that comprises a font resource can be organized and stored according to a variety of different standards, such as the Glyph Bitmap Distribution Format (BDF) for bitmap fonts, the PostScript (PS) format for outline fonts, or the Metafont description language for stroke fonts. Other proprietary or open source formats can be used to in other embodiments, and thus it will be appreciated that the present invention is not intended to be limited to management of font resource data that is stored in any particular format.

System Architecture

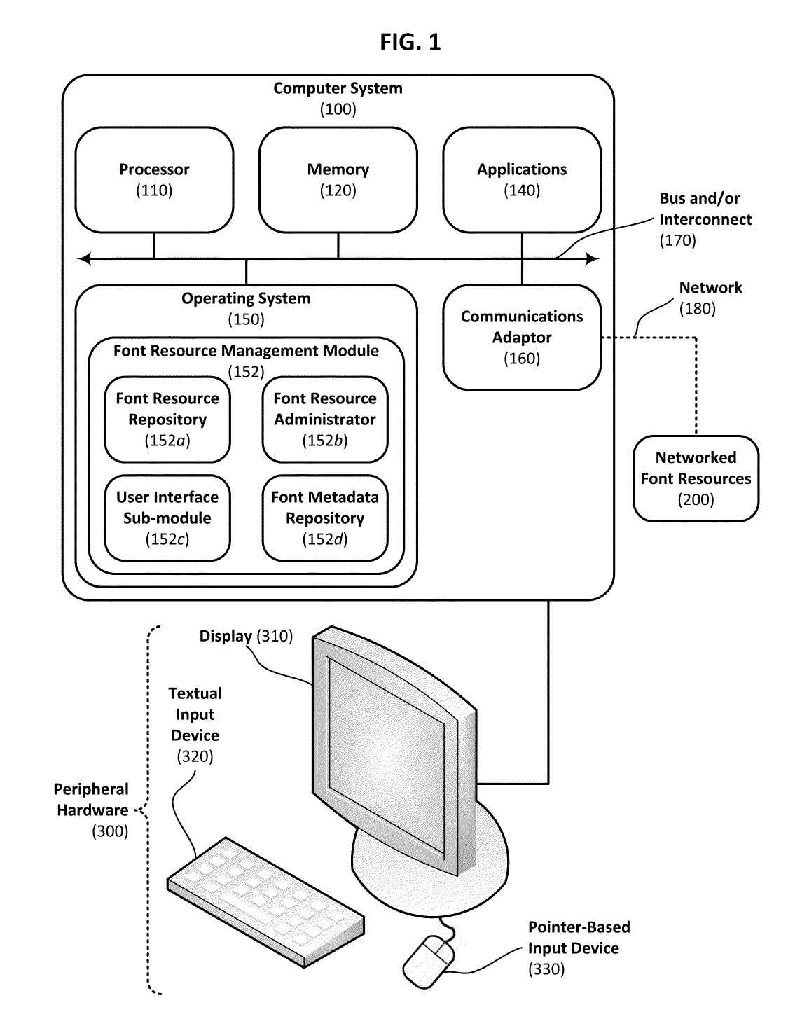

FIG. 1 is a block diagram schematically illustrating selected components of a computer system 100 that can be used to manage font resources in accordance with certain embodiments of the present invention. Computer system 100 may comprise, for example, one or more devices selected from a desktop or laptop computer, a workstation, a tablet, a smartphone, a set-top box, or any other such computing device. A combination of different devices may be used in certain embodiments. As illustrated in the example embodiment of FIG. 1, computer system 100 includes a processor 110, a memory 120, one or more applications 140, an operating system 150, and a communications adaptor 160. As can be further seen, a bus and/or interconnect 170 is also provided to allow for intra-device communications using, for example, communications adaptor 160. Computer system 100 is optionally coupled to a network 180 to allow for communications with peripheral hardware or other computing devices, such as a networked printer or a server that provides networked font resources 200. One example of such a networked font resource is an online font store or subscription service.

In certain embodiments a variety of peripheral hardware devices 300 can be coupled to or can otherwise form a part of computer system 100. As illustrated in FIG. 1, examples of such peripheral hardware devices 300 include a display 310, a textual input device 320 such as a keyboard, and a pointer-based input device 330 such as a mouse. Other peripheral devices that may be used in other embodiments include a touchscreen, a touchpad, a speaker, a printer, and/or a microphone. Certain of such peripheral devices may be capable of rendering fonts managed by computer system 100. Other componentry and functionality not reflected in the schematic block diagram of FIG. 1 will be apparent in light of this disclosure, and it will be appreciated that the claimed invention is not intended to be limited to any particular hardware configuration.

Processor 110 can be any suitable processor, and may include one or more coprocessors or controllers, such as an audio processor or a graphics processing unit, to assist in control and processing operations associated with computer system 100. Memory 120 can be implemented using any suitable type of digital storage, such as one or more of a disk drive, a universal serial bus (USB) drive, flash memory, and/or random access memory. Applications 140 may comprise any of a wide variety of software that leverages font resources provided by operating system 150. Examples of such applications 140 include word processors, desktop publishers, digital image processing tools, spreadsheets, database management systems, hardware device drivers, and operating system shells. Communications adaptor 160 can be any appropriate network chip or chipset which allows for wired and/or wireless connection to network 180 or peripheral hardware such that computer system 100 can communicate with other local and/or remote computing systems, servers, peripheral hardware devices, and/or resources.

Operating system 150 may comprise any suitable operating system, such as Google Android (Google Inc., Mountain View, Calif.), Microsoft Windows (Microsoft Corp., Redmond, Wash.), or Apple OS X (Apple Inc., Cupertino, Calif.). As will be appreciated in light of this disclosure, the techniques provided herein can be implemented without regard to the particular operating system provided in conjunction with computer system 100, and therefore may also be implemented using any suitable existing or subsequently-developed platform. As illustrated in FIG. 1, operating system 150 may include a font resource management module 152 capable of managing font resources in accordance with certain embodiments disclosed herein. While font resource management module 152 is illustrated as forming a part of the operating system in FIG. 1, in other embodiments font resource management module 152 may comprise a separate module that operates independently of, but is still capable of interacting with, operating system 150.

In certain embodiments, font resource management module 152 includes a font resource repository 152a that is configured to store font resources that can be leveraged by applications 140 and/or other components of operating system 150. Font resource repository 152a may be provided within a hidden or encrypted area of computer system 100, thereby reducing the likelihood that a user may access the font resources stored therein without authorization. As used herein, a repository that is “hidden” refers to a repository for which some measure has been taken to prevent discovery and/or access by an unauthorized user. A repository that is hidden or at least partially hidden is particularly useful in conjunction with a cloud-provisioned font subscription paradigm wherein purchased or otherwise acquired fonts are activated in a hidden client repository and remain active as long as the subscription is current. Examples of such a cloud-provisioned font subscription paradigm include Typekit (Adobe Systems Incorporated, San Jose, Calif.) and Fontdeck (Fontdeck LLC, Fulton, Md.).

It should be noted that a font resource may be present in font resource repository 152a, but may not necessarily be installed, activated, or otherwise used by operating system 150 or applications 140. Thus the mere storage of a font resource in repository 152a is not equivalent to installation or activation of such resource. Thus it will be appreciated that certain embodiments enable a user who does not have authorization to access or manage files in a hidden font resource repository 152a with the ability to nevertheless control how font resources stored therein are managed. In particular, management of font resources is distinct from generalized file management operations in an operating system since changing versions of font resources can have system-wide consequences. Thus certain of the embodiments described herein provide an end user with additional control over how such system resources are managed without providing the user with access to hidden system resources.

In certain embodiments font resource management module 152 also includes a font resource administrator 152b. Font resource administrator 152b can be configured to detect conflicts between existing fonts and fonts which are recently purchased or otherwise acquired. Font resource administrator 152b can also be configured to interface with other components of operating system 150 to manage which fonts are installed at a given time and to generate commands that result in the installation of a new font or the uninstallation of a previously installed font. Font resource administrator 152b may also be capable of generating useful information relating to installed or received fonts, since such information may help users make an informed decision about which version of a given font to use. In some cases, such information can be extracted from a font metadata repository 152d and may be presented to a user via an interface generated by a user interface sub-module 152c.

The various components of computer system 100 illustrated in FIG. 1 can be installed local to computer system 100, or may alternatively be implemented in a client-server arrangement wherein at least some of such components are provided using an applet, such as a JavaScript applet, or other downloadable module. Such a remotely accessible module can be provisioned in real-time in response to a request from computer system 100 for access to a given server having resources that are of interest to the user of computer system 100. For example, a user of a tablet computer with limited operating system functionality may obtain the functionality associated with font resource management module 152 upon accessing a cloud-based downloadable font resource manager. In some cases, such a downloadable resource may be provided via a repository of font resources such as networked font resources 200. Networked font resources 200 can be local to network 180 or remotely coupled to network 180 by one or more other networks and/or communication channels. Regardless of whether a stand-alone or networked computing scenario is used, the functionality associated with font resource management module 152 may be implemented with any suitable interface technologies that facilitate user interaction with computing system 100.

The various embodiments disclosed herein can be implemented in various forms of hardware, software, firmware, and/or special purpose processors. For example, in one embodiment a non-transitory computer readable medium has instructions encoded thereon that, when executed by one or more processors, cause one or more of the font resource management methodologies disclosed herein to be implemented. The instructions can be encoded using one or more suitable programming languages, such as C, C++, object-oriented C, JavaScript, Visual Basic .NET, BASIC, or alternatively, using custom or proprietary instruction sets. Such instructions can be provided in the form of one or more computer software applications and/or applets that are tangibly embodied on a memory device, and that can be executed by a computer having any suitable architecture. In one embodiment, the system can be hosted on a given website and implemented using JavaScript or another suitable browser-based technology, for example.

The functionalities disclosed herein can optionally be incorporated into other software applications, such as image editing software applications, word processing applications, desktop publishing applications, presentation applications, or peripheral device controller applications. For example, a word processing application can be configured to acquire font resources from a third party, and can be configured to implement certain of the functionalities disclosed herein to manage the acquired font resources. The computer software applications disclosed herein may include a number of different modules, sub-modules, or other components of distinct functionality, and can provide information to, or receive information from, still other components and/or services. These models can be used, for example, to communicate with input and/or output devices such as a display screen, a touch sensitive surface, a printer, and/or any other suitable input/output device. Other components and functionality not reflected in the illustrations will be apparent in light of this disclosure, and it will be appreciated that the claimed invention is not intended to be limited to any particular hardware or software configuration. Thus in other embodiments the components illustrated in FIG. 1 comprise additional, fewer, or alternative subcomponents.

The aforementioned non-transitory computer-readable medium may be any suitable medium for storing digital information, such as a hard drive, a server, a flash memory, and/or random access memory. In alternative embodiments, the computer and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that the present invention is not intended to be limited to any particular system architecture.

Methodology and User Interface

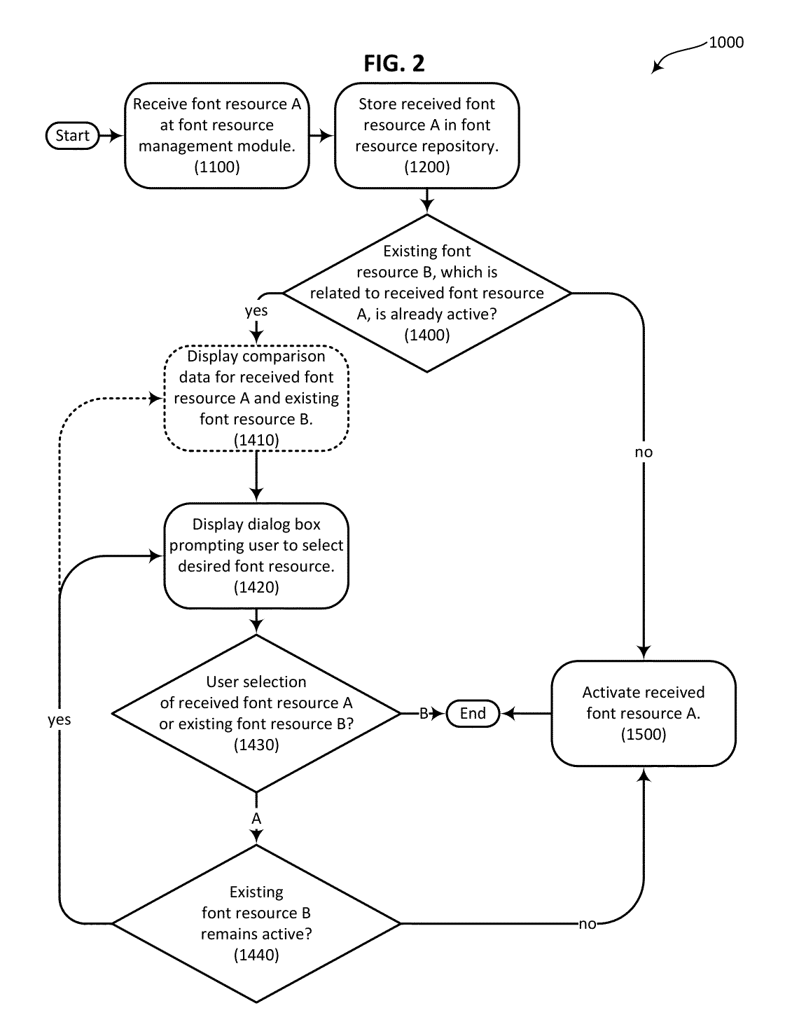

FIG. 2 is a flowchart illustrating an example method 1000 for managing font resources in accordance with certain embodiments of the present invention. Method 1000 comprises a number of phases and sub-processes, the sequence of which may vary from one embodiment to another. However, when considered in the aggregate, these phases and sub-processes form font resource management method 1000 which is responsive to user commands in accordance with certain of the embodiments disclosed herein. These methodologies can be implemented, for example, using the system architecture illustrated in FIG. 1 and described herein. However other system architectures can be used in other embodiments, as will be apparent in light of this disclosure. To this end, the correlation of the various functionalities shown in FIG. 2 to the specific components illustrated in FIG. 1, as described herein, is not intended to imply any structural and/or use limitations. Rather, other embodiments may include varying degrees of integration where multiple functionalities are performed by one system or by separate systems. For example, in an alternative embodiment separate sub-modules can be used to provide font conflict detection and font metadata extraction services. Thus other embodiments may have fewer or more modules and/or sub-modules depending on the granularity of implementation. Numerous variations and alternative configurations will be apparent in light of this disclosure.

Still referring to FIG. 2, in certain embodiments font resource management method 1000 commences with font resource management module 152 receiving a new font resource; this newly received font resource will be referred to herein as font resource A. See reference numeral 1100 in FIG. 2. In such embodiments, receipt of a new font resource may be handled by font resource administrator 152b. Receipt of a new font resource may occur as a result of a variety of events, such as a periodic update of existing font resources, purchase of a new font resource from an online service, enrollment in a subscription service that provides font resources, or downloading a font resource from a cloud-based service or other source. For example, online font subscription services will often offer multiple versions of a font, and will prompt a subscriber to select a desired version of a chosen font for subscription. Other techniques for acquiring, obtaining, or otherwise receiving font resources may be used in other embodiments.

The received font resource A can then be stored in font resource repository 152a. See reference numeral 1200 in FIG. 2. Font resource repository 152a may be provided within a hidden or encrypted area of computer system 100, thereby reducing the likelihood that a user may access the font resources stored therein without authorization. It should be appreciated that merely acquiring and storing a new font resource in font resource repository 1200 does not necessarily result in the newly received font resource being activated, installed, or otherwise used by operating system 150 or other applications 140. Thus font resource repository 152a can be understood as being capable of storing font resources regardless of whether such resources are installed or otherwise actively being used by operating system 150 or other applications 140. Thus even where an online store or subscription service prevents a user from installing and using multiple versions of a font simultaneously, a user may nevertheless acquire multiple versions of the same font in font resource repository 152a, since certain of the acquired versions may not be installed.

In certain embodiments, storing the newly received font resource A in font resource repository 152a causes a determination to be made with respect to whether there exists an existing font resource B that is related to newly received font resource A and that is already actively being used by other resources of computer system 100. See reference numeral 1400 in FIG. 2. This determination may be made by font resource administrator 152b based on an analysis of the font resources that are currently actively installed or being used by operating system 150. Two font resources may be considered as being “related to” each other where they share a common name, as will likely be the case where font resources A and B are different versions of the same font. In this context, it should be noted that there is a distinction between the name of a font that an operating system uses to identify the font and the user-facing menu name of a font, the latter being what is displayed to a user within a particular application environment. Two font resources may also be considered as being related to each other in other circumstances independent of font names, such as where metadata other than the font name matches. For example, two font resources may be considered as being related to each other where a first font resource is specifically designated as a replacement for a second font resource.

Where no conflict between font resources stored in font resource repository 152a is detected, font resource administrator 152b can be configured to activate or install newly received font resource A. See reference numeral 1500 in FIG. 2. Such installation may occur without user intervention, thus providing the user with the desired font resource A activated and available for use by applications 140 and/or operating system 150. However, newly received font resource A is not automatically installed where font resource administrator 152b detects an existing font resource B that (i) shares a common name with, or is otherwise related to, newly received font resource A, and (ii) has previously been installed or is otherwise actively being used by operating system 150, applications 140, or other resources of computer system 100. In an alternative embodiment, newly received font resource A is not automatically installed where font resource administrator 152b detects an existing font resource B that shares a common name with, or is otherwise related to, newly received font resource A, without regard to whether the existing font resource B has previously been installed or is otherwise actively being used by operating system 150, applications 140, or other resources of computer system 100.

Where newly received font resource A is not installed, font resource administrator 152b is optionally configured to compile information that compares the conflicting font resources A and B and that enables a user to make an informed decision with respect to which font resource should be installed. Such information may be compiled at least in part based on data extracted from font metadata repository 152d. Such information may additionally or alternatively include information received in conjunction with the receipt of font resource A itself, or information obtained by following a network address embedded within font resource A. Example of such information include release notes relating to new glyphs, glyph shape or glyph metric changes, or other changes that caused the font resource to be revised. Thus where a font resource conflict is detected, comparison data for received font resource A, and optionally for existing font resource B, can be displayed. See reference numeral 1410 in FIG. 2; broken lines indicate that display of such information is optional and may be omitted in certain embodiments. In certain embodiments such comparison data is displayed by user interface sub-module 152c. In some cases the displayed comparison data may include sample text rendered using font resources A and B.

Still referring to FIG. 2, where newly received font resource A is not installed, user interface sub-module 152c can be configured to display a dialog box prompting the user to select a desired font resource. See reference numeral 1420 in FIG. 2. In particular, such a dialog box can prompt the user to select whether existing font resource B should be retained as the active installed font, or whether installation of font resource A should be attempted again. Such a dialog box may include instructions, or a link to instructions, with respect to how to uninstall font resource B so as to eliminate the conflict which prevented font resource A from being installed in the first place. Display of such a dialog box provides a user who wishes to use font resource A with an opportunity to uninstall font resource B and thereby remove the conflict preventing installation of font resource A.

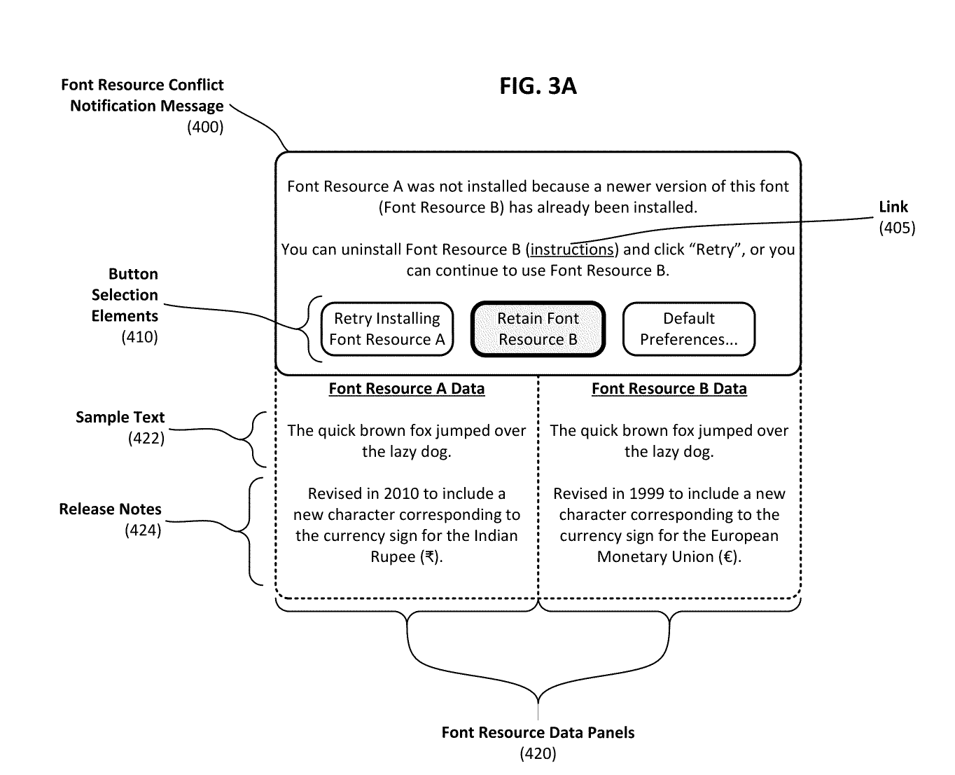

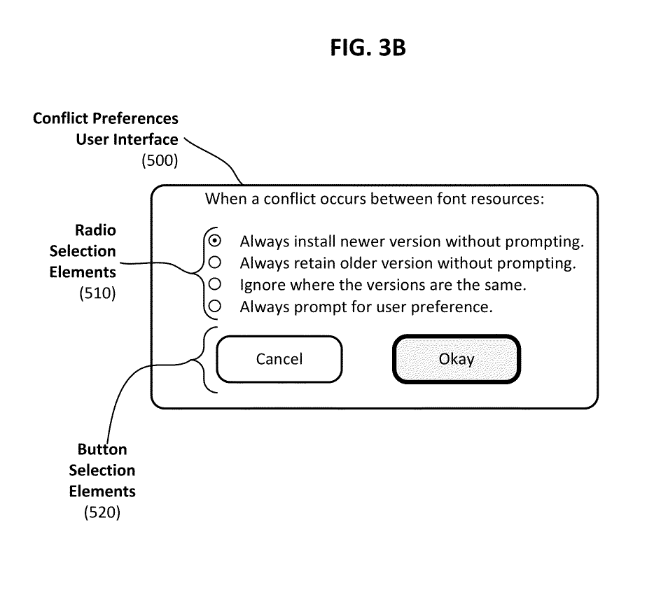

FIG. 3A illustrates an example font resource conflict notification message 400 that can be used to provide information about, and receive a user selection regarding, font resources managed by font resource management module 152. In particular, font resource conflict notification message 400 indicates that font resource A was not installed because a newer version (font resource B) has already been installed. This message 400 includes a plurality of button selection elements 410 that allow the user to retry installing font resource A or retain font resource B. Message 400 optionally includes a link 405 to instructions with respect to how to uninstall font resource B, as described herein. Message 400 also optionally includes one or more font resource data panels 420 containing, for example, sample text 422 rendered using the relevant font resources and/or release notes 424 indicating changes made to a particular font resource. In the example embodiment illustrated in FIG. 3A, relates notes 424 indicate that existing (older) font resource B was released in 1999 as a result of the addition of a new character corresponding to the currency sign for the European Monetary Union ( [symbol] ). Such release notes 424 also indicate that received (newer) font resource A was released in 2010 as a result of the addition of a new character corresponding to the currency sign for the Indian Rupee ( [symbol] ). In certain embodiments the comparison information provided via font resource data panels 420 is generated automatically in response to detection of a font resource conflict by comparing data contained within the conflicting font resources themselves, such as glyph tables or character maps. Comparison information may additionally or alternatively be extracted from font metadata repository 152d, and may include only summary information such as categories of differences, that are designated by unique identifier codes. Thus a wide variety of font-specific comparison information may be provided to the user. It will be appreciated that the present invention is not intended to be limited to provision of any specific information using any specific user interface element or elements.

While two font resource data panels 420 are illustrated in FIG. 3A, in alternative embodiments only one such panel may be displayed, for example for only the newly received font resource B. In still other alternative embodiments, the information provided in font resource data panels 420 may be provided using other types of user interface elements, such as (i) panes or extended tool tips that appear when the user hovers a pointing device over a designated area of the user interface, and/or (ii) hyperlinks to webpages or other resources that contain such information. In any case, regardless of how it is provided, such information may help a user to make an informed decision with respect to which of the conflicting font resources to use.

Still referring to FIG. 3A, in certain embodiments font resource conflict notification message 400 includes a button selection element 410 that allows default font resource conflict management preferences to be accessed and modified. For example, FIG. 3B illustrates an example conflict preferences user interface 500 that can be used to display and/or receive a user selection regarding default handling of font resource conflicts. Such a user interface may be accessed via the “Default Preferences . . . ” button selection element illustrated in FIG. 3A. Conflict preferences user interface 500 includes a plurality of radio selection elements 510 that correspond to different options for handling font resource conflicts. For example, when a font resource conflict is detected, font resource management module 152 can be configured to always install the newer version without prompting, to always retain the older version without prompting, to ignore the conflict when the two versions are the same, or to always prompt for how the user wishes to resolve the detected conflict. Other conflict handling options may be possible in other embodiments. Where the user elects to always install the newer version without prompting, font resource management module 152 can be configured to automatically uninstall, remove or delete older versions of any conflicting font resources. Conflict preferences user interface 500 may also be configured to include one or more button selection elements 520, as illustrated in FIG. 3B. It will be appreciated that where the selected default conflict handing rule “without prompting” is selected, such a default preference may later be changed by accessing conflict preferences user interface 500 through an alternative menu, such as an operating system control panel or the like. In addition, while mutually-exclusive radio selection elements 510 are illustrated in the example embodiment of FIG. 3B, in alternative embodiments wherein handling options which are not mutually exclusive are provided, other user interface elements, such as checkboxes, may be used in addition to or instead of radio selection elements.

Displaying font resource conflict notification message 400 provides a user with an opportunity to uninstall, delete, or otherwise deactivate font resource version B, thereby eliminating any conflict with font resource version A. Referring again to FIG. 2, once message 400 is displayed, user interface sub-module 152c can be configured to receive a user selection of received font resource A or existing font resource B. See reference numeral 1430 in FIG. 2. Where the user elects to continue to use existing font resource B, method 1000 can be terminated without further processing, thus providing the user with the desired font resource B activated and available for continued use by applications 140 and/or operating system 150. In such case received font resource A is optionally retained in font resource repository 152a in the event that the user wishes to use such resource later.

On the other hand, where the user elects to install received font resource A, font resource administrator 152b can be configured to determine whether existing font resource B remains active. See reference numeral 1440 in FIG. 2. Where existing font resource B remains active, for example due to an incomplete or failed uninstallation of font resource B, the user can again be prompted to resolve the still-existing conflict. This provides the user with another opportunity to either eliminate the conflict or choose instead work with font resource B. Where existing font resource B no longer remains active and the conflict is resolved, font resource administrator 152b can be configured to activate or install font resource A, thus providing the user with the desired font resource A activated and available for use by applications 140 and/or operating system 150. See reference numeral 1500 in FIG. 2. In an alternative embodiment where the user elects to install received font resource A, font resource administrator 152b can be configured to attempt to uninstall, delete or otherwise deactivate font resource B without user intervention. Where such automatic removal of the conflicting font resource B is unsuccessful, a notification message can be displayed informing the user of such failed removal and requesting the user either (i) manually remove the conflicting font resource or (ii) choose to use font resource B instead of font resource A. While certain of the embodiments disclosed herein describe font resource administrator 152b as installing, uninstalling, or otherwise manipulating font resources, in other embodiments font resource administrator 152b can be configured to generate commands that cause operating system 150 or other componentry comprising computer system 100 to perform such actions.

### CONCLUSION

Numerous variations and configurations will be apparent in light of this disclosure. For example, one example embodiment provides a method for managing font resources. The method comprises receiving, by a font resource management module, a first font resource. The method further comprises determining whether a second font resource exists in a font resource repository, the second font resource having a characteristic indicative of a conflict between the first font resource and the second font resource. Where the second font resource is determined to exist in the font resource repository, the method further comprises displaying information associated with the first font resource. The method further comprises receiving a user selection with respect to the conflict. The method further comprises providing a selected one of the first and second font resources as an active font resource for an operating system. In some cases the method further comprises making a second determination with respect to whether the second font resource exists in the font resource repository after receiving the user selection with respect to the conflict. In some cases the method further comprises removing the second font resource from the font resource repository in response to receiving the user selection. In some cases the information associated with the first font resource is displayed in response to hovering a user interface pointer over an active area within a font resource conflict notification dialog box. In some cases the method further comprises displaying information associated with the second font resource simultaneously with displaying the information associated with the first font resource. In some cases the information associated with the first font resource comprises text rendered using the first font resource. In some cases the characteristic indicative of the conflict is an identical font name. In some cases determining whether the second font resource exists further comprises comparing data provided as part of the first font resource with data provided as part of the second font resource. In some cases determining whether the second font resource exists further comprises (a) extracting metadata for the first and second font resources from a font metadata repository; and (b) comparing the extracted metadata for the first font resource with the extracted metadata for the second font resource. In some cases the font resource repository has an access restriction that prevents a user from viewing font resources stored therein.

Another example embodiment of the present invention provides a system for managing font resource. The system comprises an operating system configured to manage one or more hardware resources of a computer system. The system further comprises a memory configured to store a plurality of font resources in a font resource repository. The font resource repository has an access restriction as compared to a portion of the memory that does not include the font resource repository. The system further comprises a font resource administration module configured to receive a first font resource and determine whether a second font resource exists in the font resource repository that has a characteristic indicative of a conflict with the first font resource. The system further comprises a user interface sub-module configured to display information associated with the first font resource and receive a user selection with respect to the conflict. The font resource administration module is further configured to provide a selected one of the first and second font resources as an active font resource for the operating system. In some cases the conflict between the first and second font resources occurs only if the second font resource has been installed for use by the operating system. In some cases the font resource administration module is further configured to uninstall the second font resource from the operating system in response to receiving the user selection with respect to the conflict. In some cases the user interface sub-module is further configured to display a conflict preferences dialog box that allows a user to establish a default conflict handling rule. In some cases the access restriction comprises a restriction on viewing the font resources contained within the font resource repository. In some cases the information associated with the first font resource comprises release notes indicating a new feature associated with the first font resource. In some cases determining whether the second font resource exists in the font resource repository comprises searching the font resource repository for a font resource having an equivalent name as the first font resource.

Another example embodiment of the present invention provides a non-transient computer readable medium having instructions encoded thereon that, when executed by one or more processors, cause a font resource conflict management process to be carried out. The process comprises receiving, by a font resource management module, a first font resource. The process further comprises determining whether a second font resource exists in a font resource repository, the second font resource having a characteristic indicative of a conflict between the first font resource and the second font resource. Where the second font resource is determined to exist in the font resource repository, the process further comprises displaying information associated with the first font resource. The process further comprises receiving a user selection with respect to the conflict. The process further comprises providing a selected one of the first and second font resources as an active font resource for an operating system. In some cases the first font resource is an updated version of the second font resource. In some cases information associated with the first and second font resources is displayed where the second font resource is determined to exist in the font resource repository.

The foregoing description of the embodiments of the invention has been presented for purposes of illustration and description. It is not intended to be exhaustive or to limit the invention to the precise form described. Many modifications and variations are possible in light of this disclosure. It is intended that the scope of the invention be limited not by this detailed description, but rather by the claims appended hereto.

What is claimed is:

1. A method for managing font resources, the method comprising:
receiving, by a font resource management module, a first font resource;
determining whether a second font resource exists in a font resource repository, the second font resource having a characteristic indicative of a conflict between the first font resource and the second font resource;
where the second font resource is determined to exist in the font resource repository, displaying information associated with the first font resource;
receiving a user selection with respect to the conflict; and
providing a selected one of the first and second font resources as an active font resource for an operating system.

2. The method of claim 1, further comprising making a second determination with respect to whether the second font resource exists in the font resource repository after receiving the user selection with respect to the conflict.

3. The method of claim 1, further comprising removing the second font resource from the font resource repository in response to receiving the user selection.

4. The method of claim 1, wherein the information associated with the first font resource is displayed in response to hovering a user interface pointer over an active area within a font resource conflict notification dialog box.

5. The method of claim 1, further comprising displaying information associated with the second font resource simultaneously with displaying the information associated with the first font resource.

6. The method of claim 1, wherein the information associated with the first font resource comprises text rendered using the first font resource.

7. The method of claim 1, wherein the characteristic indicative of the conflict is an identical font name.

8. The method of claim 1, wherein determining whether the second font resource exists further comprises comparing data provided as part of the first font resource with data provided as part of the second font resource.

9. The method of claim 1, wherein determining whether the second font resource exists further comprises:
extracting metadata for the first and second font resources from a font metadata repository; and
comparing the extracted metadata for the first font resource with the extracted metadata for the second font resource.

10. The method of claim 1, wherein the font resource repository has an access restriction that prevents a user from viewing font resources stored therein.

11. A system for managing font resources, the system comprising:
an operating system configured to manage one or more hardware resources of a computer system;
a memory configured to store a plurality of font resources in a font resource repository, wherein the font resource repository has an access restriction as compared to a portion of the memory that does not include the font resource repository;
a font resource administration module configured to receive a first font resource and determine whether a second font resource exists in the font resource repository that has a characteristic indicative of a conflict with the first font resource; and
a user interface sub-module configured to display information associated with the first font resource and receive a user selection with respect to the conflict;
wherein the font resource administration module is further configured to provide a selected one of the first and second font resources as an active font resource for the operating system.

12. The system of claim 11, wherein the conflict between the first and second font resources occurs only if the second font resource has been installed for use by the operating system.

13. The system of claim 11, wherein the font resource administration module is further configured to uninstall the second font resource from the operating system in response to receiving the user selection with respect to the conflict.

14. The system of claim 11, wherein the user interface sub-module is further configured to display a conflict preferences dialog box that allows a user to establish a default conflict handling rule.

15. The system of claim 11, wherein the access restriction comprises a restriction on viewing the font resources contained within the font resource repository.

16. The system of claim 11, wherein the information associated with the first font resource comprises release notes indicating a new feature associated with the first font resource.

17. The system of claim 11, wherein determining whether the second font resource exists in the font resource repository comprises searching the font resource repository for a font resource having an equivalent name as the first font resource.

18. A non-transient computer readable medium having instructions encoded thereon that, when executed by one or more processors, cause a font resource conflict management process to be carried out, the process comprising:
receiving, by a font resource management module, a first font resource;
determining whether a second font resource exists in a font resource repository, the second font resource having a characteristic indicative of a conflict between the first font resource and the second font resource;
where the second font resource is determined to exist in the font resource repository, displaying information associated with the first font resource;
receiving a user selection with respect to the conflict; and
providing a selected one of the first and second font resources as an active font resource for an operating system.

19. The non-transient computer readable medium of claim 18, wherein the first font resource is an updated version of the second font resource.

20. The non-transient computer readable medium of claim 18, wherein information associated with the first and second font resources is displayed where the second font resource is determined to exist in the font resource repository.
